(19) United States
(12) Patent Application Publication
(10) Pub. No.: US 2024/0202321 A1
(43) Pub. Date: Jun. 20, 2024

(54) AUTOMATED COLLECTION OF FORENSIC DATA FROM AN EXPLOIT WITHOUT THE USE OF A HONEY TRAP

(71) Applicant: DELLFER, INC., NOVATO, CA (US)

(72) Inventors: KENNETH J. Wante, Winchendon, MA (US); Brian H. Pescatore, Purcellville, VA (US)

(73) Assignee: DELLFER, INC., NOVATO, CA (US)

(21) Appl. No.: 18/544,213

(22) Filed: Dec. 18, 2023

Related U.S. Application Data
(60) Provisional application No. 63/387,954, filed on Dec. 18, 2022.

(51) Int. Cl. G06F 21/54

(52) U.S. Cl. CPC G06F 21/54; G06F 2221/034

(57) ABSTRACT

Methods of collecting data from one or more exploits or attacks by cybercriminals or hackers without the use of so-called honey traps, thereby obtaining valuable forensic data without the maintenance and inefficiencies of inserting honey traps in code, such as firmware executing on IoT devices, is described. Specialized code written or adapted by a service provider is inserted into the firmware on whatever device a legitimate entity wants to protect and believes is open to exploitation or attack. Once the specialized code as been inserted, the firmware on the device is able to detect whether it is being exploited or attacked. If the device is being exploited, the specialized code determines if the exploit is known or is a new exploit. The firmware collects forensic data resulting from the exploit. This collection of forensic data is done without the cybercriminal or hacker's knowledge.

### CROSS-REFERENCE TO RELATED APPLICATIONS

This application claims priority under 35 U.S.C. § 119(e) of U.S. provisional application No. 63/387,954, filed Dec. 18, 2022, entitled “AUTOMATED HONEY POT COLLECTION”, the contents of which are hereby incorporated by reference.

### FIELD OF THE INVENTION

The present disclosure generally relates to software protection and detecting software attack vectors. More specifically, it relates to simplifying processes for obtaining data that would conventionally only be available from utilizing so-called honey traps inserted into software.

### BACKGROUND

As is known in the software security and cybersecurity field, it is useful for legitimate organizations to collect data on cyber criminals, also referred to as hackers or simply as attackers. By collecting and analyzing data on cyber criminals, legitimate organizations and the software development community more generally, can take additional measures to protect their software. Naturally, fixing the vulnerabilities and protecting against new software attack vectors are the primary defenses. However, gaining intelligence on who the enemy is and how it operates is also helpful in protecting software.

One conventional approach to gathering data on cyber criminals is the use of so-called “honey traps” in software. As the concept of honey traps is well known in the industry, details are not provided here. Simply, a honey trap is software code (referred to also as a resource) deliberately placed in a software product or on the Internet that is intended to attract cyber criminals, which can be a human being or a software bot or machine, or other entity. The idea being that the honey trap has characteristics (e.g., easily accessible, public, vulnerable, illusion of high usage, and so on) that make it a strong draw for cyber criminals in that they see it as an easy target. A cyber criminal attacks the honey trap and the honey trap implementor can then gather intelligence on the cyber criminal and how it uses what the criminal or hacker thought was an actual vulnerability. It is worth noting that usage of the honey trap or attacking it in any manner does not cause any actual harm to the honey trap implementor (i.e., legitimate entity).

However, implementing a honey trap has drawbacks. For one, it has to be created by the implementor and deliberately placed or inserted somewhere. This requires some skill and effort in that they honey trap should not be obvious or easily detectable to a cybercriminal; it should not suspect that the resource it is attacking is a honey trap. As such, a honey trap is essentially specialized software that must draw in increasingly sophisticated cyber criminals. In addition, an effective location for the honey trap must be determined. The honey trap also requires planning in that it must be set up properly and must be managed and monitored in order to obtain the intelligence data on the cyber criminal and how it is using the resource. In short, a honey trap requires overhead and maintenance.

It is also worth noting that actual vulnerabilities (not honey traps) are taken advantage of by existing software attack vectors. As is known in the industry, an attack vector from a cybercriminal is identified and given a Common Vulnerability Exposure (CVE) number. This CVE can be addressed and a patch for it is made available. Legitimate entities can use the patch to protect its software from the attack vector. However, cyber criminals may still use the attack vector repeatedly anyway given that entities are sometimes slow in installing patches. When a patch for a CVE is implemented, attacks by cyber criminals can still be made intending to take advantage of the previous vulnerability, but the legitimate entity may not know that this is being done, in many cases repeatedly, and no intelligence on the cyber criminal or how it would use the attack is being collected by the legitimate entity. Cyber criminals often prefer to use existing attack vectors that have proven to work since creating or discovering a new software attack vector is difficult and labor intensive; it takes time to craft an effective vector and many often fail.

It would be desirable to have a tool that enables honey trap functionality and utility but without having the drawbacks of creating and maintaining honey traps, as described above. It would also be desirable if the same tool was able to detect, gather and report forensic data on multiple repeated attempts (as noted above) to exploit vulnerabilities using new attack vectors or old vectors that have a CVE number and have been patched, by cyber criminals in real time.

### DESCRIPTION OF DRAWINGS

FIG. 1 is a flow diagram showing one implementation of an automated honey trap creation in accordance with one embodiment of the present invention.

### SUMMARY OF THE INVENTION

In one aspect of the present invention, a method of creating and utilizing an automated honey trap is described. A method of collecting data from one or more exploits or attacks by cybercriminals or hackers without the use of so-called honey traps, thereby obtaining valuable forensic data without the maintenance and inefficiencies of inserting honey traps in code, such as firmware executing on IoT devices, is described. As is conventional, firmware operates on devices. One way for cybercriminals or hackers to take control of a device, for example an autonomous vehicle or a low-profile motion sensor at an industrial or utility site, is to target the firmware on the car or motion detector. In one embodiment, specialized code written or adapted by a service provider, is inserted into the firmware on whatever device a legitimate entity wants to protect and believes is open to exploitation or attack. In one embodiment, the specialized code may be in the form of an API. Once the specialized code as been inserted, the firmware on the device is able to detect whether it is being exploited or attacked. If the device is being exploited, the specialized code determines if the exploit is known to the cybersecurity community or is a new or unknown exploit. The firmware, which may be referred to as protected firmware, collects forensic data resulting from the exploit. This collection of forensic data is done without the cybercriminal or hacker's knowledge. Moreover, this valuable forensic data is being collected by the legitimate entity without the use of a honey trap.

### DETAILED DESCRIPTION

In the following description, various embodiments will be described. For purposes of explanation, specific configurations and details are set forth in order to provide a thorough understanding of the embodiments. However, it will also be apparent to one skilled in the art that the embodiments may be practiced without the specific details. Furthermore, well-known features may be omitted or simplified in order not to obscure the embodiment being described.

Described herein are methods and systems for leveraging an existing software tool to detect and collect forensic data related to software attack vectors implemented by cyber criminals. The existing software tool is designed to detect and report attacks by new software attack vectors. These vectors are not yet known (to the public) and therefore have no CVE and no patches. Many of these types of vectors are referred to as “zero day attacks.” The existing tool is able to immediately stop such attacks effectively, report relevant data of the attack, and mitigate any damage from the attacks.

In one embodiment, the existing software tool (e.g., Zero Day Guard from Dellfer, Inc.) has a companion tool. This companion tool, which executes in conjunction with the primary existing software, has two capabilities. One capability is allowing the legitimate entity to use the primary tool to add code. Specifically, it allows adding code through the use of an API as described below, that allows the entity to track attack attempts (exploits) enabled by software attack vectors on the entity's products, vectors that are known and have a CVE. The second capability is leveraging an existing resource (similar to a honey trap) already in open source code that is being utilized by the legitimate entity, wherein this leveraging—as with the API—allows the entity to track attack attempts (exploits) enabled by software attack vectors on the legitimate entity's products, vectors that are known and have a CVE. The tracking in both use cases is done silently, that is, without letting the cybercriminal know that any tracking is being performed.

In one embodiment, the specialized code, described below, is inserted into the entity's application program or code. This program or code had a vulnerability or exploit that has been patched or addressed in some manner. The specialized code may be an application programming interface (API) that is inserted in the patched application, such as directly adjacent to the patched CVE code. As noted above, a cybercriminal may repeatedly attack a program with the same attack vector in an attempt to exploit a known CVE, even though the program has been patched to prevent harm from that vector. The API or specialized code detects the attacks and reports forensic data on the cyber criminal and the type of attack. This detection and forensic reporting are done without the cybercriminal knowing that intelligence about it and its futile attacks is being reported and analyzed in real time (i.e. via a honey trap). Of course, the legitimate entity which owns and runs the program being attacked will know it's being attacked.

In one embodiment, the forensic data is reported to servers under the control of a service provider. The service provider creates and inserts the specialized code or API into the entity's program. This API performs the functionality of a honey trap, but without having to create an actual honey trap and monitor and maintain it.

In one embodiment, the API or specialized code is inserted into open source code that has been patched for known CVEs and this open source code is widely deployed, for example, to IoT devices that are in widespread use. In this use case, each deployed device, potentially hundreds or thousands (e.g., if low profile IoT devices), has the functionality of a honey trap but without all the drawbacks described above. Such devices are increasingly becoming targets of cyber criminals and are attacked repeatedly, even if the exploits are known CVEs and have been patched. With use of the present invention, each device can function as a honey trap without the cybercriminal knowing that forensic data are being collected.

In one embodiment, another software protection program that protects code from unknown attack vectors, that is, ones that do not have a CVE number (sometimes referred to as zero day attacks) detects such attacks and collects forensic data on how cybercriminals are attacking the code. It is this protection program (e.g., Zero Day Guard by Dellfer, Inc.) is leveraged by the specialized code.

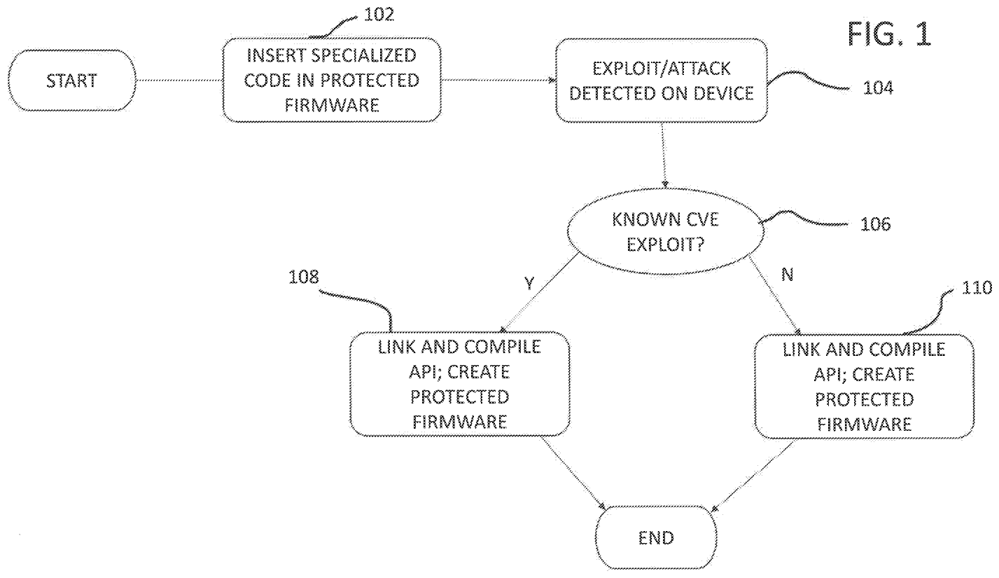

To implement the automated honey trap functionality of the present invention, the service provider performs a few steps before handing control to the legitimate entity. These are shown generally in FIG. 1. At step 102 the service provider (performing cybersecurity services for the legitimate entity) inserts the specialized code, such as an API, in the patch for a known CVE. This patch is in the legitimate entity's program, for example, protected firmware that will execute on deployed IoT devices. In one example, the API is inserted into a CVE-PATCH for code written by the entity (referred to as “My-Code” in the diagram). In other examples, the API inserted into a CVE-PATCH is code from an Open-Source library. This specialized code may not be an API in other embodiments.

At step 104 an exploit or attack is detected on the firmware or other code in the legitimate entity's device. At step 106 the specialized code that was inserted at step 102 first checks to see if the exploit is a known CVE exploit. If it is, at step 108, the API is executed. The output is a CVE number and forensic data. In another example, there is a CVE patch from an Open Source library, the same logic is performed. The specialized code detects that an attack is occurring and determines whether it is a known CVE exploit. As noted, if it is, at step 108 the API is executed with the CVE number and forensic data. This is done for as many CVE patches as needed. If there is no exploit detected, control goes to step 110 and the device executes according to unknown CVE exploit protocol.

The specialized code is then linked and compiled and the device now has protective firmware. The legitimate entity may then deploy the protective firmware on, for example, IoT devices. When cyber criminals attack the devices using known CVEs, the APIs in the patched firmware executing on those devices transmit CVE number and corresponding forensic data to the service provider which shares it with the legitimate entity. The cybercriminal does not know that this forensic data are being collected or that each device it is attacking is functioning as an automated honey trap.

What is claimed is:

1. A method of collecting forensic data from an exploit on a device without the use of a honey trap, the method comprising:
inserting specialized code in firmware executing on the device, thereby creating a protected firmware;
detecting that the exploit is targeting the device;
determining if the exploit is a known exploit; and
collecting the forensic data resulting from the exploit on the firmware on the device, the forensic data being obtained without the use of a honey trap.
